(19) United States
(12) Patent Application Publication
(10) Pub. No.: US 2023/0182369 A1
(43) Pub. Date: Jun. 15, 2023

(54) Apparatus and method for heating plastic preforms with adjustment of heating power

(71) Applicant: KRONES AG, Neutraubling (DE)

(72) Inventors: Jan TAUBER, Koefering (DE); Konrad SENN, Alteglofsheim (DE)

(21) Appl. No.: 18/080,603

(22) Filed: Dec. 13, 2022

(30) Foreign Application Priority Data
Dec. 14, 2021 (DE) 10 2021 132 983.3

(51) Int. Cl. B29C 49/78; B29C 49/64; B29C 49/42

(52) U.S. Cl. CPC B29C 49/786; B29C 49/6418; B29C 49/42065; B29C 2049/7878

(57) ABSTRACT

Disclosed is a method for heating plastic preforms, wherein the plastic preforms are transported within a heating device along a predetermined transport path and are heated to a predetermined temperature during this transport by a plurality of heating devices arranged along the transport path, and wherein a heating power of the heating devices impinging on the plastic preforms can be varied. The heating power of the heating devices impinging on the plastic preforms is controlled depending on a transport speed of the plastic preforms.

### BACKGROUND OF THE INVENTION

The present invention relates to an apparatus and a method for heating plastic preforms. Such apparatus and methods have been known in the prior art for a long time.

The plastic preforms are heated to a predetermined temperature inside a heating device, such as an oven, with a plurality of heating devices. This is usually the temperature required for blow moulding or forming the plastic preforms into plastic containers.

Known blow moulding machines have an electric stretching unit which, as is known from the internal prior art of the applicant, allows different blowing wheel speeds for the same container qualities and thus variable production figures. A speed-controllable blowing machine is also known, for example, from DE 10 2017 126 240 A1. Known filling machines and labelling machines can also vary the speed.

Up to now, however, it has not been possible to also vary the speed in the oven while maintaining the heating of the plastic preforms, since, for example, a slower transport speed through the oven would increase the dwell time of the plastic preforms in the oven and thus also the dwell time of the plastic preforms in front of the individual lamps or heating devices.

### SUMMARY OF THE INVENTION

The present invention is therefore based on the object of providing an apparatus and a method which enables the transport speed of the oven to be controlled at constant preform temperatures at the outlet of the oven. According to the invention, this object is achieved by the subject matters of the independent claims. Advantageous embodiments and further developments are the subject matter of the subclaims.

The invention is therefore directed to a method for heating plastic preforms, wherein the plastic preforms are transported within a heating device along a predetermined transport path and are heated to a predetermined temperature during this transport by means of a plurality of heating devices arranged along the transport path, and wherein a heating power of the heating devices impinging on the plastic preforms is variable.

According to the invention, the heating power of the heating devices impinging on the plastic preforms is controlled depending on a transport speed of the plastic preforms.

According to the invention, it is proposed to adjust the heating power of each heating device individually to the transport speed of the plastic preforms. In particular, the heating power of the heating devices is reduced at a slower transport speed, since the plastic preforms remain in the heating device for a longer time and thus also for a longer time in front of the individual heating devices. Accordingly, at a higher transport speed, the heating power of the heating device is increased, as the period of time during which the plastic preforms remain in the heating device is shorter.

This control of the heating power is particularly advantageous with regard to a variable blow-moulding machine, which is arranged downstream of the heating device as seen in the transport direction of the plastic preforms. The proposed method also provides control of the heating devices without much control effort. In particular, a variable output rate can thus be made possible in a simple manner even in the case of a blocked overall system with several blocked machines, such as, for example, heating device, blow-moulding machine, filling device, capper, sterilisation device or the like.

This procedure assumes that the preforms are preferably in the blow moulding machine at a certain point in time (t=0) or that they enter the machine and the blow moulding process begins. Previously, the preforms were transported through the heating device and applied with certain heating powers. As shown in more detail in the figures, this leads to a heating history that begins with the start in the first heating zone or heating device (t=SH1) and ends at the above-mentioned specific time (t=0) at which the preforms reach the blow moulding machine.

The simplified assumption is that the radiated power is constant during a heating zone (which is a gross simplification, but does not have any further impact on the final result) and thus the absorbed energy of the preforms increases linearly before each heating device is switched on and remains constant before a heating device is switched off.

The transport device is preferably a circulating transport device with straight and curved transport sections. Preferably, the transport device has a linear section along which the plastic preforms are moved along a linear transport path. Advantageously, the transport device also has at least one, preferably two, curved sections, wherein the linear sections and the curved sections preferably alternate.

Preferably, at least one curved section is a compensation zone in which no heating devices are arranged. The temperature of the plastic preform thus remains constant in the compensation zone or does not change significantly. Preferably, a transport wheel for transferring the heated plastic preforms to the subsequent blow moulding machine can also be such a compensation zone, so that the temperature of the plastic preform remains constant or at least almost constant from the last heating device until it is fed into the blow moulding machine (according to a simplified assumption).

If the transport speed is now changed, the gradient of the energy increase remains constant with a switched-on heating device, but the time the preform remains in front of the heating device and is heated by it changes. In order to achieve the same amount of energy from a heating device, the heating power must, as already mentioned above, be reduced at slower speeds and the heating power must be increased accordingly at faster speeds in order to ensure the same energy input. Preferably, a control variable of the individual heating devices is changed and in particular reduced and/or increased.

Accordingly, it is proposed to change the heating devices or their heating power or to switch them on and off in such a way that, when the heating history of each horizontal heating device is reproduced in a diagram, the energy-time curve of each heating device is as similar as possible to the original or previous setting of the heating power.

Since typically all lamps of a heating device or heating zone have the same control variable, it is preferable to keep it that way and try to readjust the energy-time curve with an overall control variable. Especially the compensation zones at the deflection and at the transport starwheel cannot be compensated without restrictions. For this reason, slightly different curves often result here. In order to nevertheless generate an energy-time curve that is as similar as possible, the energy in front of these zones can be somewhat excessive and preferably the heating power of the heating devices arranged in front of these compensation zones can be higher. The similar courses of the heating histories can take place according to various mathematical patterns and be, for example, the sum of the smallest squares of error, or also the attempt that the areas between the two different progressions are minimal or that at the end of each heating zone the energy course is identical.

This adjustment can preferably be made in the main control unit, in another edge device or in a cloud-based optimiser. In order to come close to the possible optimum, it is advisable to vary the zone power in a heating device or heating zone. For example, heating device 3 can only be operated at 30% and heating device 4, preferably at the same height, can be operated at 81%. To allow for a little more variation, one can try to do without extreme values such as over 95% when setting the basic recipe, or to do without edge heating boxes.

Preferably, the control of the heating device also enables a variable blow moulding machine. Preferably, the transport speed in the heating device can be increased if the output rate of the blow moulding machine is to be increased. Accordingly, the speed of the blow moulding machine can also be adapted to the speed of the heating device or the blow moulding process in the blow moulding machine can be changed accordingly.

Accordingly, in a preferred method, the heating power of each heating device and/or in particular also of adjacent heating devices is controlled and/or changed individually and/or independently of one another. Preferably, the heating power of each heating device can be individually controlled independently of the heating power of the other heating devices, so that the heating power can be adapted to the respective transport speed in such a way that the temperature profile to be applied to the plastic preforms is always the same independently of the transport speed. Each heating device preferably forms a separate and independent heating zone.

In a further preferred method, the heating power of the heating devices and/or the transport speed of the plastic preforms is infinitely variable. This means that, for example, the heating power of the heating device can be set to any value between a heating power of 0% and 100%. Preferably, a certain range can also be specified within which any value can be set, such as a range of 10% - 85%. This stepless control advantageously enables a very precise and fine adjustment of the heating power.

In a further preferred method, at least one heating device and preferably several heating devices are displaceably arranged along the transport path of the heating device. Preferably, the at least one heating device is displaced along the linear transport section or is displaceably arranged along the linear transport section. Particularly preferably, at least the heating device which heats the plastic preforms last or which is arranged directly in front of the compensation zone of the transport starwheel or, viewed in the transport direction of the plastic preforms, at the end of the transport device, is displaceable.

It would also be conceivable that one or more heating devices arranged at other points on the transport device are arranged in a displaceable manner, such as, for example, the first heating device and/or the heating devices arranged before and/or after the compensation zone of the curved transport section. By means of displaceable heating devices, in particular the distance to adjacent heating devices can be adjusted and also the section on the transport device when a specific and/or final temperature profile is applied to the plastic preform can be individually determined.

In a preferred method, an internal and/or external temperature of the plastic preforms is detected inside the heating device and this temperature is used to control the heating power of the heating devices. Preferably, at least one temperature sensor and especially preferably several temperature sensors are arranged within the heating device.

Preferably, the temperature sensors determine the outside and/or inside temperature of the preforms at one or more locations in order to draw conclusions about the heating history. Preferably, a superimposed regulation/control can also adjust the heating parameters based on this data. The temperature sensors may preferably, but not exclusively, be pyrometers or IR cameras. These can be advantageously pivoted to vary the measuring point. Alternatively, the measuring point can also be varied via mirrors.

It would also be conceivable that the adjustment of the heating power is made based on another control concept, which is based on a temperature of the preforms and/or a wall thickness information of the containers (or also other container characteristics such as top load ect...) on a neural network or machine learning model.

In a preferred method, the heating power is controlled via at least a first corner recipe and a second corner recipe and is preferably linearly interpolated, wherein the first corner recipe contains a first heating power and the second corner recipe contains a second heating power. Accordingly, an adjustment of the power via two corner points is also conceivable and, for example, via a connection of several regulation/control algorithms. For example, it is conceivable that a recipe is set at 95% nominal speed, this is then calculated according to the logic of the heating history to e.g. 75%, then the 75% recipe is again slightly adjusted manually and then both models are combined to set recipes of 100% -70%.

In addition, further values can preferably be adjusted. For example, it would be conceivable to adjust the ventilation in addition to the heating power. Furthermore, in order to compensate for the missing heating power in the deflection or the curved section, an additional heating box could also be arranged in the curved section.

Preferably, a pre-tempering of the preforms would also be conceivable, which would somewhat adjust the different heating histories. The logic of the adjusted heating history can refer to each horizontal heating zone or heating device individually, wherein heating zones of different heights, e.g. neighbouring heating zones, can advantageously also be combined with each other by calculation.

Since the temperature in the compensation zones cannot be compensated as easily as in the heating units, it would be conceivable that the preforms are not transported here with a chain with fixed pitches, but preferably with individual variable workpiece carriers (LLM), in order to be able to vary the speed of passage through certain zones or sections and thus better adapt the heating history.

The present invention is further directed to an apparatus for heating plastic preforms, comprising a heating device within which the plastic preforms are transported along a predetermined transport path by means of a transport device, wherein the plastic preforms are heatable to a predetermined temperature during transport by means of a plurality of heating devices arranged along the transport path, wherein a heating power of the heating devices impinging on the plastic preforms is variable.

According to the invention, the apparatus comprises a control and/or regulating device which regulates the heating power of the heating devices impinging on the plastic preforms depending on a transport speed of the plastic preforms.

Accordingly, it is also proposed on the device side to adjust the heating power of each heating device preferably individually to the transport speed of the plastic preforms and in particular to reduce the heating power of the heating devices at slower transport speeds and to increase the heating power of the heating devices at higher transport speeds.

In a preferred embodiment, the heating device has at least one and preferably a plurality of temperature sensors which detect an internal and/or an external temperature of the plastic preforms. As mentioned above, the temperature sensors preferably determine the external and/or internal temperature of the preforms at one or several locations in order to obtain conclusions about the heating history.

In a further preferred embodiment, the heating power of the heating devices can therefore be controlled as a function of the temperature detected by the temperature sensors. If, for example, the preforms have a too low temperature at a certain section of the transport path, the heating power of one or more heating devices is increased accordingly.

In a further preferred embodiment, no heating devices are arranged on at least one section of the transport path of the heating device. Preferably, these are the curved sections of the transport path.

In a preferred embodiment, the heating devices are selected from a group of heating devices including IR lamps, microwave heating devices, laser arrays and the like.

The apparatus preferably also comprises one or more further devices, such as a filling device for filling containers, a closing device for closing the containers, a sterilisation device for sterilising preforms and/or containers, or the like. Preferably, all devices are blocked or synchronised with each other, so that a control across blocks is also conceivable, which is, for example, dependent on the maximum possible filling speed.

Furthermore, the present invention is also directed to a plant for heating plastic preforms, comprising a transport device which transports the plastic preforms along a predetermined transport path, wherein the plastic preforms can be heated to a predetermined temperature during transport by means of a plurality of heating devices arranged along the transport path, and wherein a forming device for forming plastic preforms into plastic containers is arranged downstream of the plant for heating.

According to the invention, the system has a control and/or regulating device which regulates the heating power of the heating devices impinging on the plastic preforms depending on a transport speed of the plastic preforms and/or the forming device can be controlled and/or regulated depending on this transport speed.

This system also preferably comprises one or more further devices, such as, for example, a filling device for filling containers, a closing device for closing the containers, a sterilisation device for sterilising preforms and/or containers, or the like, which are blocked and/or synchronised with each other, so that control across blocks is possible.

### BRIEF DESCRIPTION OF THE DRAWINGS

Further advantages and embodiments can be seen in the attached drawings.

In the drawings:

FIG. 1 shows a first schematic embodiment of an apparatus according to the invention for heating plastic preforms;

FIG. 2 shows a schematic diagram for a heating profile of a plastic preform depending on time and energy;

FIG. 3 shows a further schematic diagram for a heating profile of a plastic preform depending on time and energy;

FIG. 4 shows a further schematic diagram for a heating profile of a plastic preform depending on time and energy; and

FIG. 5 shows a second schematic embodiment of an apparatus according to the invention for heating plastic preforms.

### DETAILED DESCRIPTION OF THE INVENTION

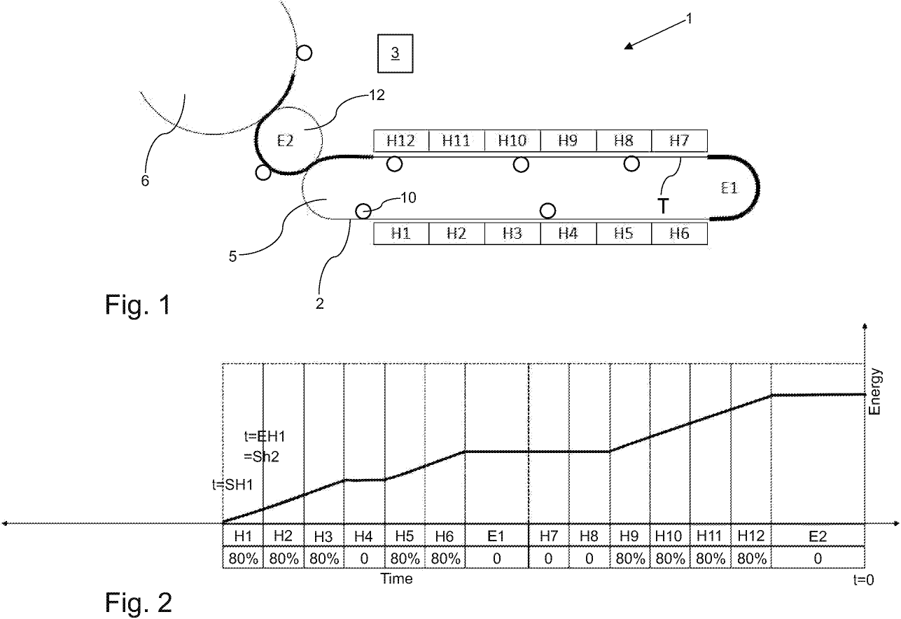

FIG. 1 shows a first schematic embodiment of an apparatus 1 according to the invention for heating plastic preforms 10. In this embodiment, the apparatus 1 has a heating device 5 and a forming device 6. The plastic preforms 10 heated within the heating device 5 are transferred to the forming device 6 by means of a transport starwheel 12.

The plastic preforms 10 are transported along a predetermined transport path T through the heating device 5 by a transport device 2 and are heated to a predetermined temperature during transport by a plurality of heating devices H1...H12 arranged along the transport path T. For this purpose, the transport device 2 has a plurality of holding devices (not shown) for holding the plastic preforms.

The reference sign 3 indicates a control and/or regulating device for regulating or changing the heating power of the heating devices H1...H12. Furthermore, it can be seen that no heating devices are arranged within a curved section of the transport device 2, which is preferably a compensation zone E1. Furthermore, the transport starwheel 12 forms a second such compensation zone E2. The temperature of the plastic preforms 10 preferably remains constant in the compensation zones E1, E2 or at least does not change significantly.

FIG. 2 shows a schematic diagram for a heating profile of a plastic preform depending on time and energy. The temperature profile is shown depending on time or the individual heating devices H1...H12. In this example, the heating devices H1...H3, H5, H6 and H9...H12 are set to a heating power of 80%, while the heating devices H4, H7 and H8 are completely switched off. It can also be seen that the energy or temperature of the preforms remains constant in the switched-off heating devices and the compensation zones E1 and E2, while the temperature in the heating devices H1...H3, H5, H6 and H9...H12 increases and in particular rises linearly.

The time t=0 indicates the time at which the heated plastic preform is transferred to the blow moulding machine and the time t=SH1 indicates the time at which the preform is at the first heating device H1. Accordingly, the time t=SH2 indicates the time at which the preform is at the second heating device H2.

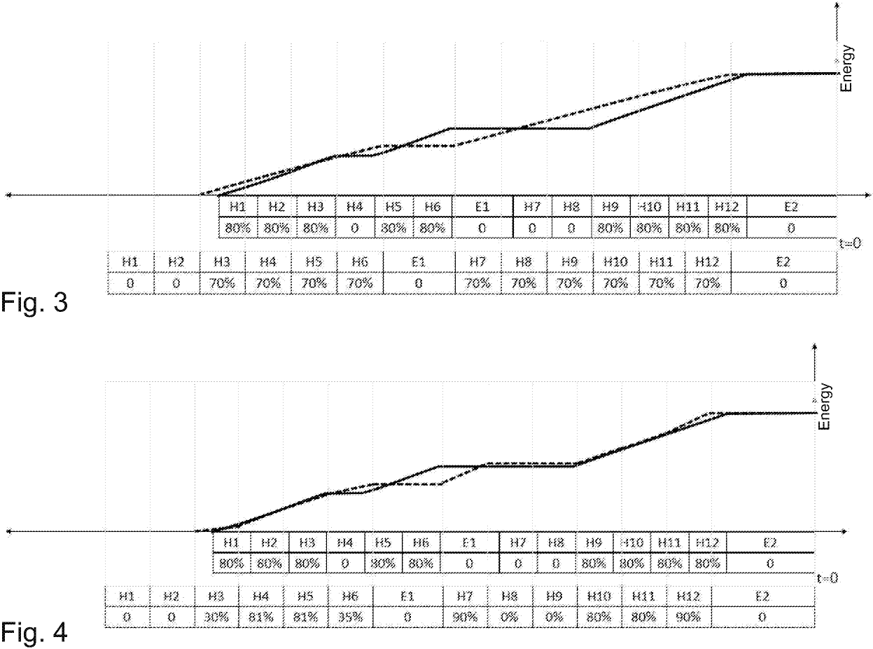

FIG. 3 shows a further schematic diagram for a heating profile of a plastic preform depending on time and energy. The course of the solid line corresponds to the course shown in FIG. 2.

The dashed line is the temperature profile of the preform with changed heating capacities of the heating devices H1...H12. The lower, likewise dotted table shows that the heating devices H1 and H2 are switched off and the power of the heating devices H3...H12 has been changed to 70%.

The heating power was thus reduced compared to the solid line/table, since the plastic preforms were transported through the heating device at a lower transport speed and thus remained longer in front of the individual heating devices.

The diagram illustrates that despite the change in speed, an almost identical heating profile is possible over time and, in particular, an identical temperature at the end.

FIG. 4 shows a further schematic diagram for a heating profile of a plastic preform depending on time and energy. Here, too, the solid line corresponds to the curve shown in FIG. 2.

FIG. 4 shows in particular another possibility of adapting the heating power of the heating devices H1...H12, but which again results in an approximately identical heating profile, as illustrated by the dashed line. The associated (dashed) table shows that in this example the heating devices H1, H2, H8 and H9 are completely switched off and the remaining heating devices, unlike in the example shown in FIG. 3, have different heating powers. The heating device H3 is operated at 30%, the heating devices H4 and H5 at 81%, the heating device H6 at 35%, the heating devices H7 and H12 at 90% and the heating devices H10 and H11 at 80%.

FIGS. 3 and 4 illustrate in particular that when the transport speed is changed by the heating device, almost similar temperature profiles with identical final temperature can still be produced on the plastic preforms by different settings of the heating power of the heating devices.

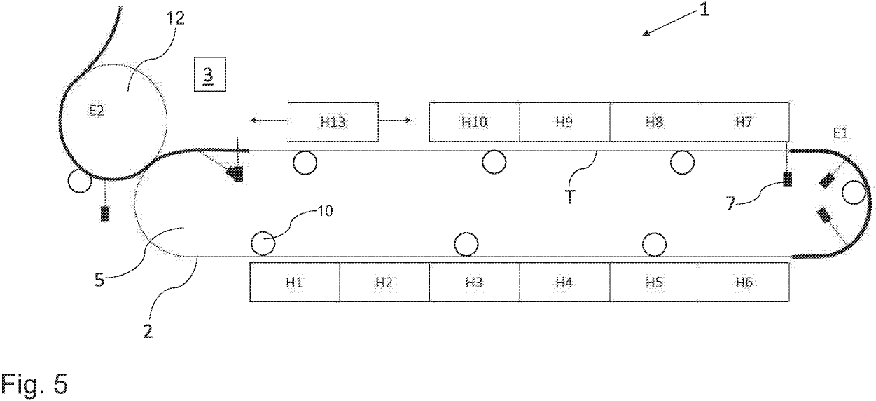

FIG. 5 shows a second schematic embodiment of an apparatus 1 according to the invention for heating plastic preforms 10. The apparatus 1 shown here corresponds essentially to the apparatus shown in FIG. 1, so that reference is no longer made here to the reference signs already included in the description of FIG. 1.

Unlike the embodiment shown in FIG. 1, however, the apparatus here also has several temperature sensors 7 which can detect an internal and/or external temperature of the plastic preforms 10. Such a temperature sensor 7 could, for example, also be arranged on the transport starwheel 2, as can be seen in FIG. 5. The arrangement of the temperature sensors in the apparatus is exemplary and not limited to this arrangement. Rather, they can be arranged at any point in the apparatus.

Furthermore, in FIG. 5 the heating device H13 is displaceably arranged, as illustrated by the arrows. The arrangement of this movable heating device is not limited to the arrangement shown. Rather, any other heating device can be arranged in a displaceable manner or the heating device can also have several displaceable heating devices.

The applicant reserves the right to claim all features disclosed in the application documents as essential to the invention, provided they are individually or in combination new compared to the prior art. It is further pointed out that the individual figures also describe features which may be advantageous in themselves. The skilled person immediately recognises that a certain feature described in a figure can also be advantageous without adopting further features from this figure. Furthermore, the skilled person recognises that advantages can also result from a combination of several features shown in individual figures or in different figures.

List of reference signs

| | |
|---|---|
| 1 | apparatus |
| 2 | transport device |
| 3 | control and/or regulation device |
| 5 | heating device |
| 6 | forming device |
| 7 | temperature sensor |
| 10 | plastic preforms |
| 12 | transport starwheel |
| E1, E2 | compensation zone |
| H1...H13 | heating devices |
| T | transport path |

1. A method for heating plastic preforms, wherein the plastic preforms are transported along a predetermined transport path within a heating device and are heated to a predetermined temperature during this transport by a plurality of heating devices arranged along the transport path, and wherein a heating power of the heating devices impinging on the plastic preforms can be varied, wherein
the heating power of the heating devices impinging on the plastic preforms is controlled depending on a transport speed of the plastic preforms.

2. The method according to claim 1, wherein
the heating power of each heating device and/or also of adjacent heating devices is controlled and/or changed individually and/or independently of each other.

3. The method according to claim 1, wherein
the heating power of the heating devices and/or the transport speed of the plastic preforms is continuously controlled.

4. The method according to claim 1 wherein
at least one heating device is displaceably arranged along the transport path of the heating device.

5. The method according to claim 1, wherein
an internal and/or external temperature of the plastic preforms is detected within the heating device and this temperature is used to control the heating power of the heating devices.

6. The method according to claim 1, wherein
the heating power is controlled via at least a first and a second corner recipe and is linearly interpolated, wherein the first corner recipe containing a first heating power and the second corner recipe containing a second heating power.

7. An apparatus for heating plastic preforms, having a heating device within which the plastic preforms are transported along a predetermined transport path by a transport device, wherein the plastic preforms are heated to a predetermined temperature during transport by a plurality of heating devices arranged along the transport path wherein a heating power of the heating devices which impinges on the plastic preforms is changeable, wherein
the apparatus has a control and/or regulating device configured to regulate the heating power of the heating devices impinging on the plastic preforms depending on a transport speed of the plastic preforms.

8. The apparatus according to claim 7, wherein
the heating device has at least one temperature sensor configured to detect an internal and/or an external temperature of the plastic preforms.

9. The apparatus according to claim 8, wherein
the heating power of the heating devices can be controlled depending on the temperature detected by the temperature sensors.

10. The apparatus according to claim 7, wherein
no heating devices are arranged on at least one section of the transport path of the heating device.

11. The apparatus according to claim 7, wherein
the heating devices are selected from a group of heating devices consisting of IR lamps, microwave heating devices and laser arrays.

12. An installation for heating plastic preforms, having a transport device which transports the plastic preforms along a predefined transport path, wherein the plastic preforms are heated to a predefined temperature during transport by a plurality of heating devices arranged along the transport path, and wherein a forming device for forming plastic preforms into plastic containers is arranged downstream of the installation for heating, wherein
the installation has a control and/or regulating device which regulates the heating power of the heating devices impinging on the plastic preforms depending on a transport speed of the plastic preforms and/or the forming device can be controlled and/or regulated depending on this transport speed.
